(19) United States
(12) Patent Application Publication
(10) Pub. No.: US 2007/0083849 A1
(43) Pub. Date: Apr. 12, 2007

(54) Auto-learning RIS/PACS worklists

(75) Inventor: William Murray Stoval III, Mount Prospect, IL (US)

Correspondence Address: MCANDREWS HELD & MALLOY, LTD, 500 WEST MADISON STREET, SUITE 3400, CHICAGO, IL, 60661, US

(73) Assignee: General Electric Company

(21) Appl. No.: 11/320,127

(22) Filed: Dec. 28, 2005

Related U.S. Application Data
(60) Provisional application No. 60/725,942, filed on Oct. 12, 2005.

(51) Int. Cl. G06F 9/44

(52) U.S. Cl. 717/104

(57) ABSTRACT

Certain embodiments of the present invention provide a method for generating an auto-learning worklist. The method includes tracking read case data. The method also includes automatically configuring a worklist based at least in part on the read case data. Certain embodiments of the present invention provide a method for using an auto-learning worklist. The method includes reading a first case from the auto-learning worklist. The method also includes pre-loading a second case from the auto-learning worklist while the first case from the auto-learning worklist is being read.

### RELATED APPLICATIONS

This application claims the benefit of U.S. Provisional Patent Application No. 60/725,942, filed Oct. 12, 2005, which is herein incorporated by reference.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to medical workflow. In particular, the present invention relates to auto-learning worklists.

Healthcare environments, such as hospitals or clinics, include clinical information systems, such as hospital information systems (HIS) and radiology information systems (RIS), and storage systems, such as picture archiving and communication systems (PACS). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during surgery, medical personnel may access patient information, such as images of a patient's anatomy, that are stored in a medical information system. Alternatively, medical personnel may enter new information, such as history, diagnostic, or treatment information, into a medical information system during an ongoing medical procedure.

PACS connect to medical diagnostic imaging devices and employ an acquisition gateway (between the acquisition device and the PACS), storage and archiving units, display workstations, databases, and sophisticated data processors. These components are integrated together by a communication network and data management system. A PACS has, in general, the overall goals of streamlining health-care operations, facilitating distributed remote examination and diagnosis, and improving patient care.

A typical application of a PACS system is to provide one or more medical images for examination by a medical professional. For example, a PACS system can provide a series of x-ray images to a display workstation where the images are displayed for a radiologist to perform a diagnostic examination. Based on the presentation of these images, the radiologist can provide a diagnosis. For example, the radiologist can diagnose a tumor or lesion in x-ray images of a patient's lungs.

A reading, such as a radiology or cardiology procedure reading, is a process of a healthcare practitioner, such as a radiologist or a cardiologist, viewing digital images of a patient. The practitioner performs a diagnosis based on a content of the diagnostic images and reports on results electronically (e.g., using dictation or otherwise) or on paper. The practitioner, such as a radiologist or cardiologist, typically uses other tools to perform diagnosis. Some examples of other tools are prior and related prior (historical) exams and their results, laboratory exams (such as blood work), allergies, pathology results, medication, alerts, document images, and other tools.

Computer-aided diagnosis (CAD) of image data may be utilized by practitioners to aid in reading medical images. CAD software can identify and mark features, abnormalities, and/or anomalies in medical images to bring to the attention of the practitioner. In addition, CAD software can generate a report of the identified features, abnormalities, and/or anomalies. The practitioner may then review the marked images and/or reports prior to making a final diagnosis.

A clinical or healthcare environment is a crowded, demanding environment that would benefit from organization and improved ease of use of imaging systems, data storage systems, and other equipment used in the healthcare environment. A healthcare environment, such as a hospital or clinic, encompasses a large array of professionals, patients, and equipment. Personnel in a healthcare facility must manage a plurality of patients, systems, and tasks to provide quality service to patients. Healthcare personnel may encounter many difficulties or obstacles in their workflow.

A variety of distractions in a clinical environment may frequently interrupt medical personnel or interfere with their job performance. Furthermore, workspaces, such as a radiology workspace, may become cluttered with a variety of monitors, data input devices, data storage devices, and communication device, for example. Cluttered workspaces may result in inefficient workflow and service to clients, which may impact a patient's health and safety or result in liability for a healthcare facility. Data entry and access is also complicated in a typical healthcare facility.

With increasing volumes of examinations and images, a reduction of radiologists, and mounting pressures on improving productivity, radiologists and other healthcare personnel are in need of image processing or display workflow enhancements that aid in prioritizing workflow. Currently, healthcare personnel utilize worklists to organize and priorities their workflow. Worklists show a list of exams or procedures. A worklist may list provide a list of exams for a radiologist to read, for example. Worklists may show new exams or procedures as new cases are created in the system. The worklist may allow the radiologist to organize the exams to be read based on time received or patient name, for example.

The creation and configuration of worklists in radiology information systems (RIS) and/or picture archiving and communication systems (PACS) is a very manual process. A highly trained person is required to create specific SQL (or equivalent) in order to customize the worklists for users. This process does not scale. Often, for a large institution, this is only done, that is, configured, for the key users, such as, for example, radiologists, and some basic unread type worklists are setup for the rest of the users. This results in an inefficient use of the user's time, since in many cases they will have to sort through the worklists to find the appropriate cases to read, or at a minimum, manually re-order the cases based upon their preferences. This also prevents the user, for example, a radiologist, from being able to use software options like dictation macros where the next exam off of the worklist is automatically loaded, because it might not be the correct exam. Instead, they must go back to the worklist, reselect an exam, and re-open the next case, further slowing down the reading process. For expensive resources like radiologists who can read a large number of exams in a day, being able to streamline this process is a great productivity opportunity.

Thus, there is a need for a worklist that automatically tracks users preferences. More particularly, there is a need for a RIS/PACS worklist that automatically tracks cases read by radiologists in an institution. There is also a need for a worklist that enhances other productivity tools, such as dictation macros.

### BRIEF SUMMARY OF THE INVENTION

Certain embodiments of the present invention provide a method for generating an auto-learning worklist. The method includes tracking read case data. The method also includes automatically configuring a worklist based at least in part on the read case data. In an embodiment of the present invention, the read case data may be based at least in part on at least one of a body part, a procedure name, a procedure description, a modality, a modality station name, a modality station location, a patient location, a patient age, a patient acuity, a patient availability, and a department. In an embodiment of the present invention, the read case data may be continually tracked. In an embodiment of the present invention, the read case data may be based at least in part on a sampling of read cases. In an embodiment of the present invention, the worklist may be automatically configured based at least in part on an algorithm. The algorithm may include at least one weighting factor. In an embodiment of the present invention, the method may further include reading a first case from the worklist while pre-loading a second case from the worklist. The second case from the worklist may be pre-loaded based at least in part on a voice command.

Certain embodiments of the present invention provide a computer-readable medium. The computer-readable medium includes a set of instructions for execution on a computer. The set of instructions includes a tracking routine configured to track read case data and a worklist generation routine configured to automatically generate a worklist based at least in part on the read case data. In an embodiment of the present invention, the read case data may be based at least in part on at least one of a body part, a procedure name, a procedure description, a modality, a modality station name, a modality station location, a patient location, a patient age, a patient acuity, a patient availability, and a department. In an embodiment of the present invention, the read case data may be continually tracked. In an embodiment of the present invention, the read case data may be based at least in part on a sampling of read cases. In an embodiment of the present invention, the worklist may be automatically configured based at least in part on an algorithm. The algorithm may include at least one weighting factor. In an embodiment of the present invention, the set of instructions may further include reading a first case from the worklist while pre-loading a second case from the worklist. The second case from the worklist may be pre-loaded based at least in part on a voice command.

Certain embodiments of the present invention provide a system for generating an auto-learning worklist. The system includes a tracking component and a worklist configuration component. The tracking component is capable of tracking read case data. The worklist configuration component is capable of automatically configuring a worklist based at least in part on the read case data. In an embodiment of the present invention, the system may include a radiology information system (RIS). In an embodiment of the present invention, the system may include a picture archiving and communication system (PACS). In an embodiment of the present invention, the read case data may be based at least in part on at least one of a body part, a procedure name, a procedure description, a modality, a modality station name, a modality station location, a patient location, a patient age, a patient acuity, a patient availability, and a department.

Certain embodiments of the present invention provide a method for using an auto-learning worklist. The method includes reading a first case from the auto-learning worklist. The method also includes pre-loading a second case from the auto-learning worklist while the first case from the auto-learning worklist is being read. In an embodiment of the present invention, the second case from the auto-learning worklist may be pre-loaded based at least in part on a voice command.

### BRIEF DESCRIPTION OF SEVERAL VIEWS OF THE DRAWINGS

FIG. 1 illustrates a current worklist interface.

FIG. 2 illustrates a flow diagram of a method for generating an auto-learning worklist in accordance with an embodiment of the present invention.

FIG. 3 illustrates a system for generating an auto-learning worklist in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

While the following description is made with reference to radiologists in hospitals, it should be understood that the present invention is not limited to radiologists or hospitals, and that many other worklist users in many other settings may benefit as well.

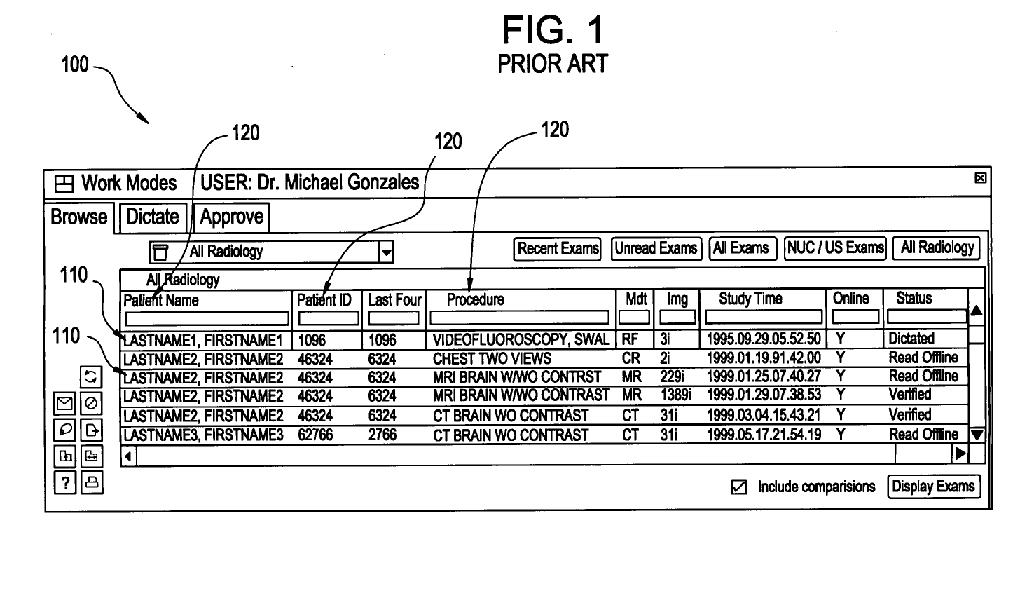

FIG. 1 illustrates a current worklist interface 100. The worklist interface 100 includes rows for each entry 110 in the worklist. The worklist interface 100 includes columns 120 that separate fields in each worklist entry 110.

In operation, a user may use the worklist interface 100 to view, organize, and/or process entries 110 in the user's worklist. A user may be a physician, radiologist, technician, or other healthcare provider, for example. A worklist entry 110 may correspond to a particular patient, procedure, study, and/or set of images, for example. For example, a radiologist may utilize worklist interface 100 to view the sets of images, as indicated by each entry 110 in the worklist, he has to read. Selecting a worklist entry 110 may bring up one or more images associated with the entry. For example, a radiologist may select a worklist entry 110 to read a set of CT image slices associated with that entry.

The columns 120 in the worklist interface 100 correspond to fields in each worklist entry 110. Columns 120 may correspond to fields such as, for example, patient name, patient identifier, procedure, and modality.

The worklist interface 110 may provide various mechanisms to organize worklist entries 110. For example, a user may select a button in the interface 110 to display recent exams. As another example, a user may select a button in the interface 110 to display unread exams. As another example, a worklist may be sorted using the worklist columns 120. For example, a radiologist may utilize worklist interface 100 to sort worklist entries 110 by patient name by selecting the “patient name” column 120 to locate an entry 110 for a particular patient to see the corresponding procedure information.

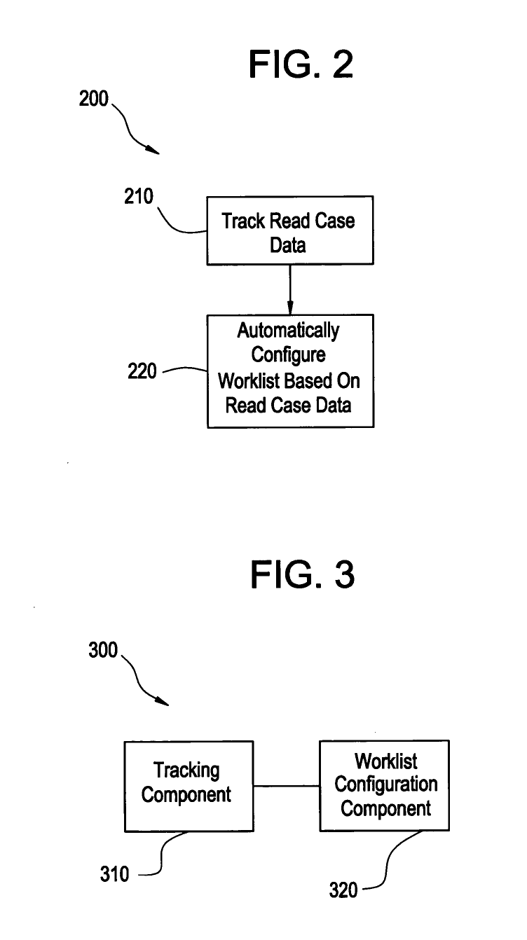

FIG. 2 illustrates a flow diagram of a method 200 for generating an auto-learning worklist in accordance with an embodiment of the present invention. The method 200 includes tracking read case data 210 and configuring a worklist based at least in part on the read case data 220.

At step 210, the read case data may be tracked. More particularly, the read case data may be tracked based at least in part on one or more categories, such as body part, procedure name, procedure description, modality, modality station name, modality station location, patient location, patient age (e.g., is the patient a minor?), acuity status (e.g., is the case stat?), patient availability (e.g., is the patient waiting?), department, and/or other categories.

In an embodiment, the read case data may include the total number of cases read by a user in a particular category (“BaseStat”). For example, if a radiologist read 20 computed tomography (CT) exams and 10 magnetic resonance (MR) exams, then “BaseStat=20” for “Modality=CT” and “BaseStat=10” for “Modality=MR”. Additionally, a single case may fit into multiple categories. For example, if a radiologist read 20 head CT exams, then “BaseStat=20” for “BodyPart=Head” and “BaseStat=20” for “Modality=CT”.

In an embodiment of the present invention, the read case data may include the total number of cases read by each user (“StatSumA”). For example, if a radiologist read 20 head CT exams and 10 chest MR exams, then “StatSumA=30”.

In an embodiment of the present invention, the read case data may include the total number of (read and unread) cases in a worklist (“StatSumB”). The cases in the worklist may be for a one user or multiple users. For example, if there are 40 head CT exams and 20 chest MR exams in a worklist, then “StatSumB=60”.

In an embodiment of the present invention, the read case data may include a percentage of time that a user selects an available case in a particular category from a worklist (“PercPick”). For example, if a radiologist selects a CT exam, followed by an MR exam (assuming a CT exam was not available), followed by another CT exam, then “PercPick=1” for “Modality=CT”. Additionally, “PercPick” may be determined for the worklist and/or the visible portion of the worklist (for example, only the cases that are visible to a radiologist without scrolling).

In an embodiment of the present invention, the read case data may include a ranking of a user as compared to other users for a particular category (“UserRank”). For example, if Radiologist A reads 60 CT exams, Radiologist B reads 40 CT exams, and a total of 100 CT exams are read, then for “Modality=CT”, “UserRank=1” for Radiologist A and “UserRank=2” for Radiologist B. “UserRank” for other modalities, such as MR, and/or other categories, such as body part, may be different than “UserRank” for “Modality=CT”.

As appreciated by one of ordinary skill in the art, “UserRank” may be normalized for prior to use in an algorithm and/or formula, particularly if combined with other normalized statistics, such as percentages. For example, “UserRank” may be normalized as follows:
NormalizedUserRank=[(Number of Users)−(UserRank)+1)]/(Number of Users) (1)

In an embodiment of the present invention, the read case data may be continually tracked in real-time mode. For example, the read case data may be updated as each new case is read. In an embodiment of the present invention, the read case data may be tracked in batch mode. For example, the read case data may be sampled based at least in part on a predetermined group of users and/or a predetermined period of time.

At step 220, a worklist may be configured based at least in part on the read case data. The worklist may be configured by creating a new worklist. Alternatively, the worklist may be configured by modifying (e.g. reordering and/or otherwise adjusting) an existing worklist.

In an embodiment of the present invention, the worklist may be configured based at least in part on an algorithm. The algorithm may include the read case data and one or more weighting factors (W_{1→N}, X_{1→N}, Y_{1→N}, Z_{1→N}), where N is the total number of categories and W, X, Y, and Z are different weighting factors. For example, the algorithm may include the following formula:
For i=1→N, W[i]*(BaseStat[i]/StatSumA)+X[i]*(BaseStat[i]/StatSumB)+Y[i]*(PercPick[i])+Z[i]*(UserRank[i]) (2)
As appreciated by one or ordinary skill in the art, many other algorithms and/or formulas may be implemented to configure the worklist.

In an embodiment of the present invention, the weighting factors may be selected and/or adjusted by an institution based at least in part on any or all of the categories. For example, if a hospital is interested in head CT exams, then the weighting factors corresponding to “BodyPart=Head” and “Modality=CT” may be selected and/or adjusted accordingly. As a further example, if a hospital is interested in comparing radiologists, then the weighting factor Z, which corresponds to “UserRank” may be selected and/or adjusted accordingly. One or more of the weighting factors for any or all of the categories may be zero. For example, if a hospital is not interested in chest MR exams, then the corresponding weighting factors for BodyPart=Chest” and “Modality=CT” may be set to zero.

In an embodiment of the present invention, the worklist may be configured in real-time mode. For example, the aforementioned algorithm may be run as each new case is read. In an embodiment of the present invention, the worklist may be configured in batch mode. For example, the aforementioned algorithm may be run for a predetermined group of users and/or at predetermined period of time.

In an embodiment of the present invention, the worklist may be automatically configured based at least in part on the read case data. In an embodiment of the present invention, the worklist may be manually configured based at least in part on the read case data.

In an embodiment of the present invention, a first case in an auto-learning worklist may be read while a second case is pre-loaded. More particularly, the second case may be pre-loaded by a voice command. For example, an auto-learning worklist may enhance the functionality of a dictation macro for a radiologist by pre-loading a specific “next” case as opposed to a randomly-ordered “next” case. Consequently, in light of this enhanced functionality, radiologists are more likely to use dictation macros, and thus further improve productivity.

One or more of the steps of the method 200 may be implemented alone or in combination in hardware, firmware, and/or as a set of instructions in software, for example. Certain embodiments may be provided as a set of instructions residing on a computer-readable medium, such as a memory, a magnetic disk, an optical disk, or a hard disk, for execution on a computer or other processing device, such as a radiology information system (RIS) or picture archiving and communication system (PACS) workstation or one or more dedicated processors.

Certain embodiments of the present invention may omit one or more of these steps and/or perform the steps in a different order than the order listed. For example, some steps may not be performed in certain embodiments of the present invention. As a further example, certain steps may be performed in a different temporal order than listed above, including simultaneously.

FIG. 3 illustrates a system 300 for generating an auto-learning worklist in accordance with an embodiment of the present invention. The system 300 includes a tracking component 310 and a worklist configuration component 320.

The tracking component 310 may be capable of tracking read case data, as described above with respect to step 210 of FIG. 2. The worklist configuration component 320 may be capable of configuring a worklist based at least in part on the read case data, as described above with respect to step 220 of FIG. 2. The tracking component 310 may be in communication with the worklist configuration component 320.

In operation, the tracking component 310 of the system 300 may track statistics, such as BaseStat, StatSumA, StatSumB, PercPick, UserRank and/or other read case data, as described above. In an embodiment, the tracking component 310 may track the statistics for each time that a user, such as a radiologist, reads a case or exam, or views an image. In an embodiment, the tracking component 310 may sample the statistics based at least in part on a selected user group and/or time period.

Next, the tracking component 310 may transfer the statistics to the worklist configuration component 320 of the system 300. The worklist configuration component 320 may configure a worklist based at least in part on the statistics. More particularly, the worklist configuration component 320 may run an algorithm to configure the worklist. The algorithm may be run in real-time mode or in batch mode, for example. The results of the algorithm may be used to create a new worklist or reorder an existing worklist, for example.

In an embodiment of the present invention, the worklist configuration component 220 may be capable of automatically configuring the worklist based at least in part on the read case data. In an embodiment of the present invention, the worklist configuration component 220 may be capable of manually configuring the worklist based at least in part on the read case data.

In an embodiment of the present invention, the system 300 may include a radiology information system (RIS). More particularly, the tracking component 310 and/or the worklist configuration component 320 may include one or more RIS workstations.

In an embodiment of the present invention, the system 300 may include a picture archiving and communication system (PACS). More particularly, the tracking component 310 and/or the worklist configuration component 320 may include one or more PACS workstations.

The components, elements, and/or functionality of system 300 may be implemented alone or in combination in various forms in hardware, firmware, and/or as a set of instructions in software, for example. Certain embodiments may be provided as a set of instructions residing on a computer-readable medium, such as a memory, a magnetic disk, an optical disk, or hard disk, for execution on a general purpose computer or other processing device, such as, for example, a RIS or PACS workstation or one or more dedicated processors.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for generating an auto-learning worklist, the method including:
tracking read case data; and
automatically configuring a worklist based at least in part on the read case data.

2. The method of claim 1, wherein the read case data may be based at least in part on at least one of a body part, a procedure name, a procedure description, a modality, a modality station name, a modality station location, a patient location, a patient age, a patient acuity, a patient availability, and a department.

3. The method of claim 1, wherein the read case data is continually tracked.

4. The method of claim 1, wherein the read case data is based at least in part on a sampling of read cases.

5. The method of claim 1, wherein the worklist is automatically configured based at least in part on an algorithm.

6. The method of claim 5, wherein the algorithm includes at least one weighting factor.

7. The method of claim 1, further including reading a first case from the worklist while pre-loading a second case from the worklist.

8. The method of claim 7, wherein the second case from the worklist is pre-loaded based on a voice command.

9. A computer-readable medium including a set of instructions for execution on a computer, the set of instructions including:
a tracking routine configured to track read case data; and
a worklist generation routine configured to automatically generate a worklist based at least in part on the read case data.

10. The set of instructions of claim 9, wherein the read case data is based at least in part on at least one of a body part, a procedure name, a procedure description, a modality, a modality station name, a modality station location, a patient location, a patient age, a patient acuity, a patient availability, and a department.

11. The set of instructions of claim 9, wherein the read case data is continually tracked.

12. The set of instructions of claim 9, wherein the read case data is based at least in part on a sampling of read cases.

13. The set of instructions of claim 9, wherein the worklist is automatically configured based at least in part on an algorithm.

14. The set of instructions of claim 13, wherein the algorithm includes at least one weighting factor.

15. The set of instructions of claim 9, further including reading a first case from the worklist while pre-loading a second case from the worklist.

16. The set of instructions of claim 15, wherein the second case from the worklist is pre-loaded based on a voice command.

17. A system for generating an auto-learning worklist, the system including:
a tracking component, wherein the tracking component is capable of tracking read case data; and
a worklist configuration component, wherein the worklist configuration component is capable of automatically configuring a worklist based at least in part on the read case data.

18. The system of claim 17, wherein the system includes a radiology information system (RIS).

19. The system of claim 17, wherein the system includes a picture archiving and communication system (PACS).

20. The system of claim 17, wherein the read case data is based at least in part on at least one of a body part, a procedure name, a procedure description, a modality, a modality station name, a modality station location, a patient location, a patient age, a patient acuity, a patient availability, and a department.

21. A method for using an auto-learning worklist, the method including:
reading a first case from the auto-learning worklist; and
pre-loading a second case from the auto-learning worklist while the first case from the auto-learning worklist is being read.

22. The method of claim 21, wherein the second case from the auto-learning worklist is pre-loaded based on a voice command.
